(19) United States
(12) Patent Application Publication
(10) Pub. No.: US 2011/0145005 A1
(43) Pub. Date: Jun. 16, 2011

(54) METHOD AND SYSTEM FOR AUTOMATIC BUSINESS CONTENT DISCOVERY

(76) Inventors: Wu Cao, Redwood City, CA (US); Balaji Gadhiraju, Cupertino, CA (US); Sridhar Gantimahapatruni, Alameda, CA (US); David Kung, Cupertino, CA (US); Marc Maillart, Sunnyvale, CA (US); Awez Syed, San Jose, CA (US); Aun-Khuan Tan, Sunnyvale, CA (US)

(21) Appl. No.: 12/634,967

(22) Filed: Dec. 10, 2009

(51) Int. Cl. G06Q 10/00; G06F 17/30; G06F 11/28; G06F 3/048

(52) U.S. Cl. 705/1.1; 707/769; 715/764; 707/E17.014; 714/E11.178

(57) ABSTRACT

A system and method for automatic business content discovery are described. In various embodiments, a system includes modules to bind business terms to data validation rules and search data sources for data matching data validation rules. In various embodiments, the system binds matching data to data validation rules. In various embodiments, a user interface is provided for creating and managing business terms and data validation rules. In various embodiments, a method for profiling and monitoring data via graphical controls is presented.

### FIELD OF THE INVENTION

The invention relates generally to automatic business content discovery, and more specifically, to discovering business content via data validation rules bound to business terms.

### BACKGROUND OF THE INVENTION

Organizations today have large data stores storing business content in the form of Information Technology (IT) assets. Business content may be information critical for the business and its operations. For example, an enterprise may store different types of data in different systems such as legacy systems, enterprise information systems, relational databases, object databases, file stores, and so on.

Within a huge infrastructure and a complex IT landscape, an organization may have the need to organize, profile, and monitor data periodically. Because of a complex IT landscape, the organization may need to employ IT professionals to profile data manually. Thus, the monitoring and profiling of data may consume a lot of resources.

Many organizations have operations in different geographic regions and intricate supply chains involving many stakeholders. As data sources become larger and the complexity of the data exchanged on a daily basis is increased because of increasing numbers of stakeholders as operations grow, it may be beneficial for an organization to streamline the profiling and monitoring of data.

### SUMMARY OF THE INVENTION

These and other benefits and features of embodiments of the invention will be apparent upon consideration of the following detailed description of preferred embodiments thereof, presented in connection with the following drawings.

In various embodiments, a method to automatically discover business content is described. The method of the various embodiments includes binding business terms to data validation rules, discovering business content based on data validation rules and binding business content to data elements. In various embodiments, data is profiled and monitored using data validation rules.

In various embodiments, a system is described. The system of the embodiments includes a catalog to store business terms and data validation rules, a data services engine to discover business content from a variety of data sources, and a user interface.

In various embodiments, a user interface provides dialogs and screens for creating business terms and data validation rules. The user interface also provides dialogs and screens for data analysis and profiling.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram of an embodiment for automatic business content discovery.

FIG. 2 is a flow diagram of an embodiment for searching for data elements matching a data validation rule.

FIG. 3 is a flow diagram of an embodiment for periodically profiling and monitoring data.

FIG. 4 is a block diagram of a system of an embodiment for automatic business content discovery.

FIG. 5 is a flow diagram of an embodiment for generating business terms and data validation rules and performing automatic business content discovery.

FIG. 6 is an exemplary block diagram of a system of an embodiment.

### DETAILED DESCRIPTION

Embodiments of techniques for ‘Method and System for Automatic Business Content Discovery’ are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

Metadata is information about information. Metadata typically constitutes a subset or representative values of a larger data set. Metadata describes how structure and calculation rules are stored, plus, optionally, additional information on data sources, definitions, transformations, quality, date of last update, user privilege information, etc.

A data source is a source of information, such as a database. A data source table is a database table, structured file, or the like whose data content is used at least in part to define the data content of a target table by mapping at least a portion of the data content of the data source table to the target table using a data federation program.

Data sources include sources of data that enable data storage and retrieval. Data sources may include databases, such as, relational, transactional, hierarchical, multidimensional (e.g., OLAP), object oriented databases, and the like. Further data sources may include tabular data (e.g., spreadsheets, delimited text files), data tagged with a markup language (e.g., XML data), transactional data, unstructured data (e.g., text files, screen scrapings), hierarchical data (e.g., data in a file system, XML data), files, one or more reports, and any other data source accessible through an established protocol, such as, Open Data Base Connectivity (ODBC) and the like. Data sources may also include a data source where the data is not stored like data streams, broadcast data, and the like.

Master data contains information that is needed often and in some predictable or accepted form. Master data may be stored in a computer system, in a network of computer systems or in a variety of data stores. Master data may be persistent data that defines data relevant for the operation of a company or organization.

For example, the master data of a cost center contains the name of the cost center, the person responsible for the cost center, and the corresponding hierarchy area. In another example, the master data of a vendor contains the name, address, and bank information for the vendor. In a further example, the master data of a user in a computer system may contain the user's authorizations in the system, the name of their default printer, and other information.

A business term is a term used in an organization to describe an asset of the organization. Business terms are collected in a vocabulary of words and phrases, or notation systems. Using business terms, users describe the content type of their data, for example, employee, social security number, driver's license number, address, etc. Master data of an organization may be defined and described as a business term and stored in a business term repository or catalog.

A simple business term describes an atomic content of a basic data element (e.g., social security number and purchase order number). A compound business term is a business term which incorporates several simple business terms. For example, the compound business term employee may incorporate several simple business terms such as name, last name, social security number, etc.

The content type of a piece of data may describe the nature of the data as required by the definition of the data in a business term.

A business term can also be bound to reference data. In that case, only values of the business terms from the pool of reference data are valid. For example, a name may be required to be checked and found in a name dictionary. In another example, company name may be required to be checked and found in a firm name dictionary. Such reference data can be used if the format of the business term cannot be uniformly defined. For example, a social security number is a sequence of 9 digits in a prescribed format so its format is standard. However, a name cannot be expected to have an exact number of characters in an exact format.

Business terms may also have parent-child relationships. For example, the business term “organization” may have “employees.” Thus, employee business terms are child business terms to the parent business term organization.

Some business data may have data validation rules that define the basic structure or pattern of a data element representing such data. For example, a social security number is a sequence of digits in the format “999-99-9999.” Data validation rules to be applied to simple business terms are simple rules. Data validation rules to be applied to compound terms are compound rules. A compound rule is a collection of rules that are relevant for a term. For example, a compound rule for an employee business term may define that the employee term is expected to have four fields, such as “name”, “address”, “social security number”, and “driver's license number.” If such a data element is found, further rules to match each of the fields to a business term will be applied. For example, four rules will be applied to verify that the employee data element not only has the four required fields, but also each field is of a required format.

In various embodiments, a data validation rule may specify that a business term conforms to reference data. Such embodiments are relevant for data in business terms that cannot be uniformly specified in a format, such as, but not limited to, names.

According to various embodiments, business terms, their definitions, and data validation rules are stored in a catalog as a repository. A catalog may hold business terms relevant for an organization. For example, one organization may define the business term “employee” to have a social security number, a name, and an address. Another organization may define the business term “employee” to have an ID, a name, a social security number, and a driver's license number.

In various embodiments, data quality tools assess the state of completeness, validity, consistency, timeliness and accuracy of a data set in view of a specific use, because different requirements may exist for data in different uses. In other words, in one use of data there may be required that the data is 99% accurate; while in another use of the data it may be required that the data is 97% accurate.

In various embodiments, a system may be implemented to maintain a repository of business terms and data validation rules. In various embodiments, the bindings may be applied to tie business terms to one or more data validation rules that apply to the terms. So for instance, a repository may contain a textual definition of a term and bindings that bind the term to one or more data validation rules. In various embodiments, the system may be configured to periodically discover data elements related to selected business terms in selected data sources that conform to the one or more data validation rules bound to the term. Data elements that are found to satisfy their respective data validation rules may then be bound to the data validation rules. This additional binding is also referred to as “profiling” and serves as a stamp of validity of the data element. Furthermore, the system may periodically monitor data elements to determine whether they continue to satisfy their corresponding data validation rules.

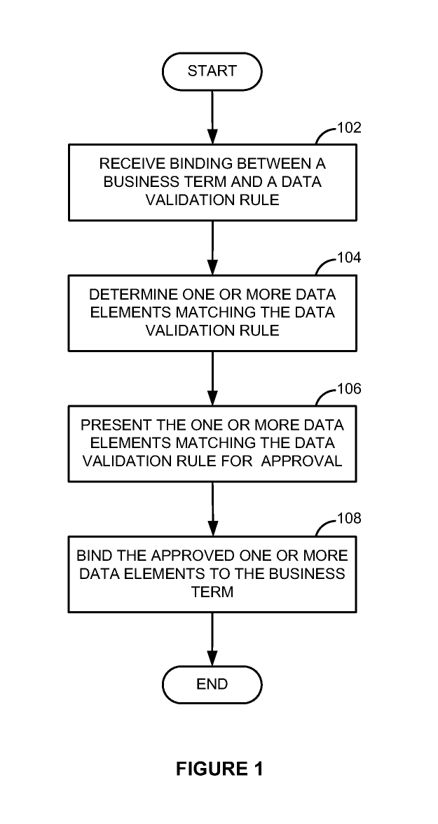

FIG. 1 is a flow diagram of an embodiment of a method of automatic business content discovery to discover data elements in selected data stores that match data validation rules associated with selected business terms. Referring to FIG. 1, at process block 102, bindings between a business term and the one or more data validation rules associated with it as defined in a catalog are received from the catalog. At process block 104, data elements that match the one or more data validation rules associated with the business term are determined. The data elements may be retrieved from a variety of specified data sources such as, but not limited to, relational databases, enterprise information systems, file stores, and so on. Having determined the data elements, they are then presented to a user (e.g., via a user interface) for approval of the data elements as having sufficiently matched the data validation check. At process block 106, the one or more data elements matching the data validation rule are presented for approval and, at process block 108, the approved one or more data elements are bound to the data validation rule.

In an exemplary embodiment, an exemplary business term “SSN” may stand for social security number and may be bound to an exemplary data validation rule specifying a format for the SSN as “999-99-9999.” According to the process described in FIG. 1, the exemplary embodiment may find a data element matching the format specified in the data validation rule. After an approval is received, the data element matching the specified format is also bound to the data validation rule. Thus, from that point forward all instances of a social security number will be required to have the format specified in the data validation rule, thus ensuring the accuracy and completeness of the data.

In various exemplary embodiments, the following exemplary code may be used to generate a data validation rule for a social security number:

SSNRule(SSN)

{

return (match_pattern (SSN, ‘999-99-9999’) ;

}.

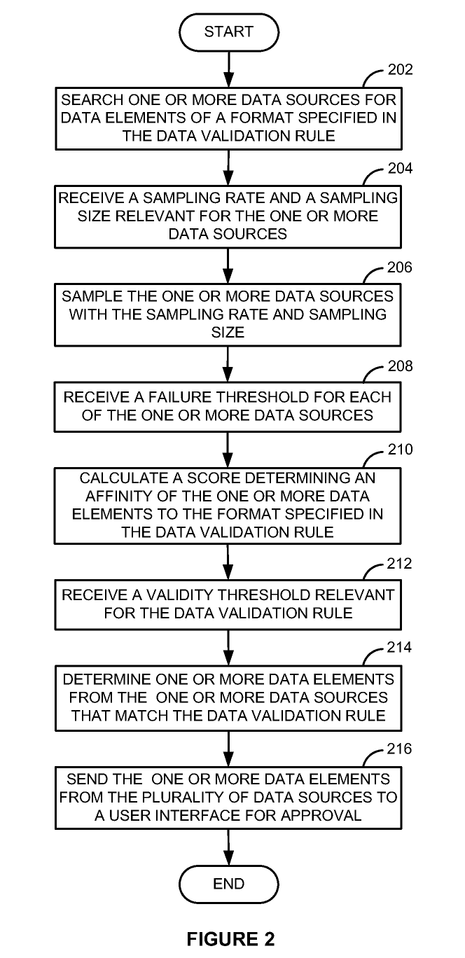

FIG. 2 is a flow diagram of an embodiment of a method of searching selected data sources for data elements matching one or more data validation rules (e.g., 104 at FIG. 1). Referring to FIG. 2, at block 202, one or more data sources are searched for data elements with a format specified in a data validation rule. At block 204, a sampling rate and a sampling size for conducting the search are received. The sampling rate and sampling size may be included to limit the number of data elements (records) in the data sources targeted during search because the data sources may have many records and the search may be too slow if all records are processed at once. Thus, at process block 206, at least one of the data sources is sampled with the received sampling rate and sampling size. At process block 208, a failure threshold is received. The failure threshold represents a value of the accepted number of failed attempts to find data elements in a data source that match data validation rules (failed attempts may also be referred to as non-matching records). If the failure threshold is reached, it may be determined that the data source may not hold data elements of the specified format. Thus, processing may also be improved, because when the failure threshold is reached, the search may move to other data sources. At process block 210, a score to determine the affinity of a data element to the specified format of the data validation rule is calculated. In various embodiments, the calculated score may be used to determine if and how many fields of data match the fields in a compound business term. For example, if the data validation rule specifies a format relevant for a compound business term and the compound business term is to include four fields, the calculated score will represent how many of the required fields are actually found in data in searched data sources. Other calculations can be used to quantify the level of compliance of particular data elements to a data validation rule.

At process block 212, a validity threshold is relevant for the data validation rule is received. In various embodiments, the validity threshold may be used to determine a likeliness of data to match one or more data validation rule. At process block 214, the data elements matching the format specified in the data validation rule are determined. At process block 216, the data elements determined to have matched the rules are sent to a user interface for approval.

In various embodiments, data in business terms may also be used in searching data sources for matching data elements. For example, a business term can contain valid values which can be used in matching data elements. Further, a business term may include sample data that can be used in matching data elements. A business term can also include a definition to be used in matching data elements form data sources. Using both data in data validation rules and business terms to match data elements may be useful in searching data sources as data elements may be matched more efficiently and more precisely. Also, better matching techniques can result in savings of time and resources.

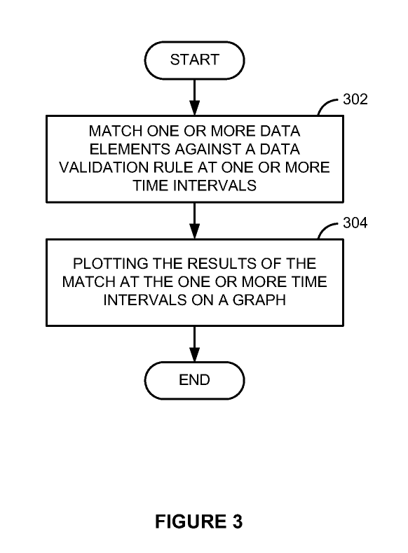

FIG. 3 is a flow diagram of an embodiment for periodic profiling and monitoring of data. Referring to FIG. 3, at block 302, one or more data elements bound to a data validation rule are matched to the data validation rule at one or more intervals of time. In various embodiments, the one or more data elements may be validated at regular or random time intervals. In various embodiments, the one or more data elements may be validated on demand. Validating the one or more data elements after they have been initially bound to a data validation rule may be beneficial to ensure that the data in the data element continues to conform to the format specified in the data validation rule over time. Thus, it may be determined that the data element holds data of an expected quality as required by the data validation rule. At process block 304, results of the match at one or more time intervals are plotted on a graph to describe the quality of data in the one or more data elements as defined by the data validation rule. Thus, the resulting graph may be used to monitor the quality of data in data elements over time.

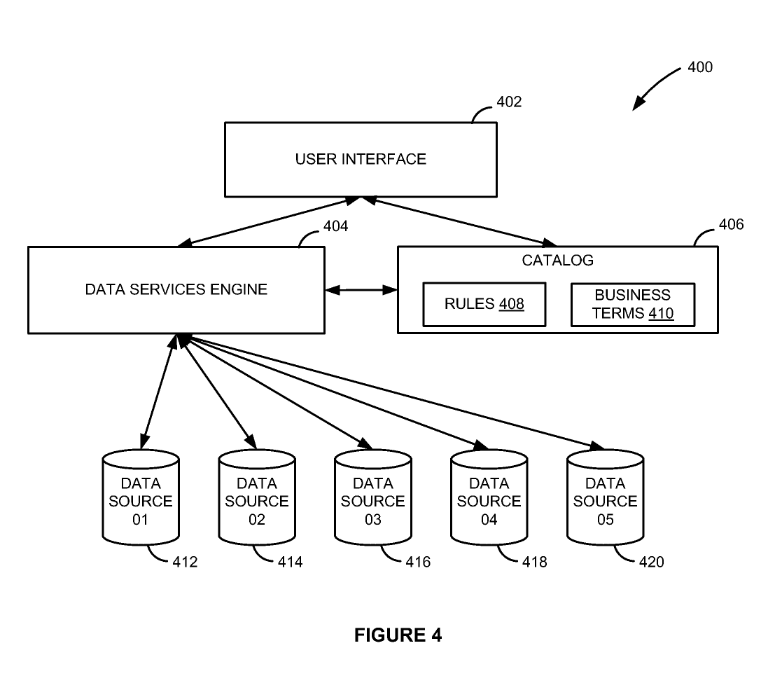

FIG. 4 is a block diagram of a system of an embodiment operable for automatic business content discovery. Referring to FIG. 4, the system 400 includes a catalog at block 406. The catalog is a repository of metadata such as data validation rules 408 and business terms 410. The system 400 further includes a data services engine 404. The data services engine 404 searches selected data sources, e.g., data source 01 at block 412 through to data source 05 at block 420 for data elements matching a data validation rule from the data validation rules 408 in the catalog 406. The system 400 provides a user interface 402 for displaying the business terms 410 and the data validation rules 408 and provides user interface elements for binding the business terms 410 to data validation rules 408. The user interface can also provide a rules editor for adding, editing and removing rules and their bindings. The user interface 402 further displays the results of searches performed by the data services engine 404 for a user to approve. The user interface 402 also provides user interface elements for binding a data element matching a data validation rule to the data validation rule. The user interface 402 may also display a graph representing the conformity of the data in a data element to a format specified in the data validation rule over a selected period of time.

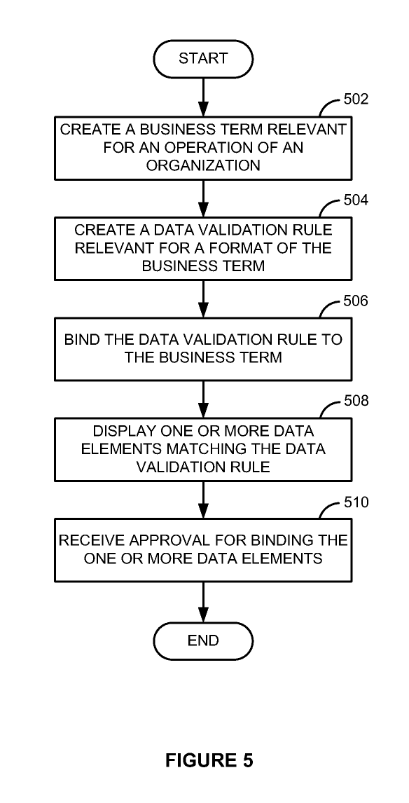

FIG. 5 is a flow diagram of an embodiment of a method of generating business terms, data validation rules, and binding the rules to business terms in order to perform automatic business content discovery. Referring to FIG. 5, at process block 502, a business term relevant for an operation of an organization is created in a user interface. The business term may be created by a user specifying a definition for the business term via the user interface to update a catalog. At process block 504, a data validation rule is created in a user interface. The data validation rule specifies a format of the data as may be required by the definition of the business term. At process block 506, the data validation rule is bound to the business term. At process block 508, the user interface displays one or more data elements that match the data validation rule. At process block 510, an approval for binding is received in the user interface for the one or more data elements. Thus, the data elements that are bound to rules they conform to will be expected to contain data of the format specified in the data validation rule. In various embodiments, the binding of the data element to the data validation rule may be used to monitor the data in the data element at regular or random time intervals.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable medium as instructions. The term “computer readable medium” should be taken to include a single medium or multiple media that stores one or more sets of instructions. The term “computer readable medium” should be taken to include any article that is capable of undergoing a set of changes to store, encode, or otherwise carry a set of instructions for execution by a computer system which causes the computer system to perform any of the methods or process steps described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as that produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

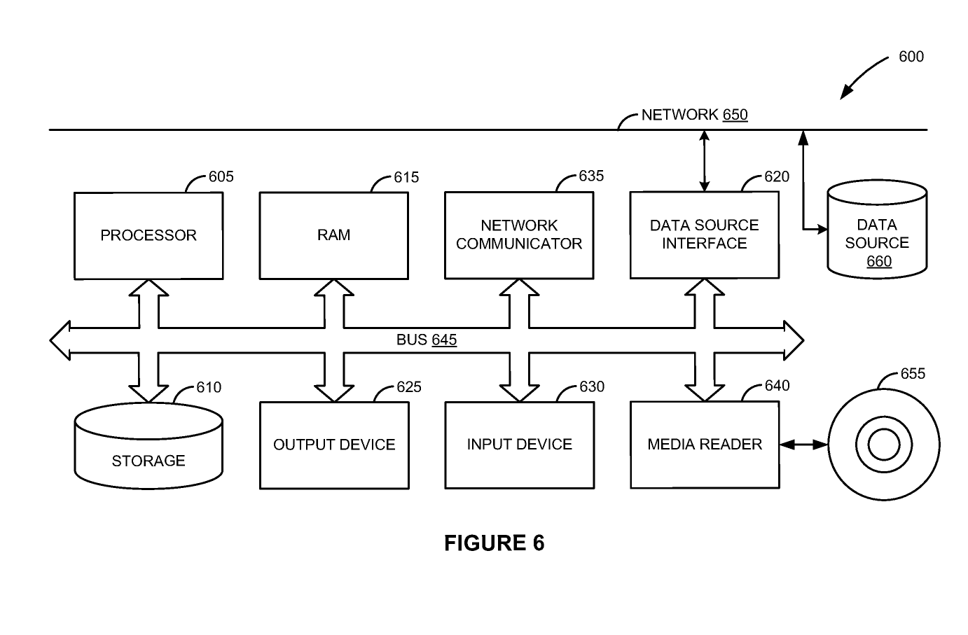

FIG. 6 is a block diagram of an exemplary computer system 600. The computer system 600 includes a processor 605 that executes software instructions or code stored on a computer readable medium 655 to perform the above-illustrated methods of the invention. The computer system 600 includes a media reader 640 to read the instructions from the computer readable medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interacting with the computer system 600. Each of these output 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be access via one or more abstraction layers implemented in hardware or software. For example, the data source 660 may be access by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, one or more reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

A semantic layer is an abstraction overlying one or more data sources. It removes the need for a user to master the various subtleties of existing query languages when writing queries. The provided abstraction includes metadata description of the data sources. The metadata can include terms meaningful for a user in place of the logical descriptions used by the data source. For example, common business terms in place of table and column names. These terms can be localized and or domain specific. The layer may include logic associated with the underlying data allowing it to automatically formulate queries for execution against the underlying data sources. The logic includes connection to, structure for, and aspects of the data sources. Some semantic layers can be published, so that it can be shared by many clients and users. Some semantic layers implement security at a granularity corresponding to the underlying data sources'structure or at the semantic layer. The specific forms of semantic layers includes data model objects that describe the underlying data source and define dimensions, attributes and measures with the underlying data. The objects can represent relationships between dimension members, and provide calculations associated with the underlying data.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A machine-readable storage device having machine readable instructions tangibly stored thereon which when executed by the machine, causes the machine to perform a method of automatic business content discovery, the method comprising:
receiving a binding between a business term and a data validation rule;
determining one or more data elements matching the data validation rule; and
binding the one or more matching data elements to the data validation rule.

2. The machine-readable storage device of claim 1, wherein the binding between the business term and the data validation rule is received from a catalog defining the business term, wherein the data validation rule specifies a format relevant for the business term; and
the business term includes one or more definitions, one or more values, and one or more sample data.

3. The machine-readable storage device of claim 1, wherein the method further comprises receiving a validity threshold relevant for the data validation rule and determining the one or more data elements matching the data validation rule comprises determining that the matching is above the validity threshold.

4. The machine-readable storage device of claim 1, wherein binding the one or more data elements to the data validation rule is performed in response to receiving an approval relevant for the one or more data elements.

5. The machine-readable storage device of claim 1, wherein the method further comprises receiving a binding of the business term to a set of reference data, wherein the reference data includes a set of values relevant for the business term.

6. The machine-readable storage device of claim 1, wherein determining the data elements matching the data validation rule comprises:
searching one or more data sources for data elements having data in a format specified in the data validation rule;
determining the one or more data elements from the one or more data sources to match the data validation rule; and
sending the one or more data elements from the one or more data sources to a user interface for approval.

7. The machine-readable storage device of claim 6, wherein searching the one or more data sources comprises:
receiving a sampling rate and a sampling size relevant for the one or more data sources; and
sampling the one or more data sources with the sampling rate and sampling size.

8. The machine-readable storage device of claim 6, wherein searching the one or more data sources further comprises receiving a failure threshold for each of the one or more data sources, wherein the failure threshold specifies a value for a number of expected non-matching data elements in each of the one or more data sources, wherein searching is terminated if the failure threshold is reached.

9. The machine-readable storage device of claim 6, wherein determining further comprises calculating a score determining an affinity of the one or more data elements to the format specified in the data validation rule.

10. The machine-readable storage device of claim 1, wherein the method further comprises matching the one or more data elements against the data validation rule at one or more time intervals.

11. The machine-readable storage device of claim 10, wherein the operations further comprise plotting the matching at one or more time intervals on a graph.

12. A computerized system including a processor, the processor communicating with one or more memory devices storing instructions, the system comprising:
a catalog operable to receive metadata, the metadata representing business terms and data validation rules; and
a data services engine operable to determine an affinity of one or more data elements from one or more data sources to a format specified in the metadata.

13. The system of claim 12, further comprising a user interface operable to:
display the one or more data elements from the data services engine; and
receive one or more bindings for the one or more data elements to the metadata.

14. The system of claim 12, wherein the catalog comprises:
one or more business terms, wherein the one or more business terms include one or more definitions, one or more values, and one or more sample data; and
one or more data validation rules bound to the one or more business terms.

15. A computerized method, comprising:
creating a business term relevant for an operation of an organization;
creating a data validation rule relevant for a format of the business term;
binding the data validation rule to the business term;
determining one or more data elements matching the data validation rule based on a score; and
binding the one or more data elements to the data validation rule.

16. The computerized method of claim 15, wherein the business term comprises one or more fields, wherein each of the one or more fields is relevant for an atomic unit of data.

17. The computerized method of claim 15, wherein determining comprises calculating the score for each of the one or more data elements, wherein the score represents a plurality of fields in each of the one or more data elements matching a plurality of fields required by the data validation rule.

18. The computerized method of claim 15, wherein binding the one or more data elements to the data validation rule comprises:
receiving the one or more data elements in a user interface;
receiving approval for one or more of the one or more data elements from a user;
and
establishing a connection between the one or more data elements and the data validation rule.

19. The computerized method of claim 15, wherein creating a business term comprises adding values to one or more user interface elements in a catalog.

20. The machine-readable storage device of claim 15, wherein creating a data validation rule comprises:
receiving the business term in a user interface;
creating a statement expressing a format relevant for the business term in the user interface.
